(19) United States
(12) Patent Application Publication
(10) Pub. No.: US 2013/0232110 A1
(43) Pub. Date: Sep. 5, 2013

(54) METHOD AND APPARATUS FOR SAVING A DOCUMENT

(71) Applicants: PEKING UNIVERSITY FOUNDER GROUP CO., LTD., Beijing (CN); BEIJING FOUNDER APABI TECHNOLOGY LTD., Beijing (CN)

(72) Inventors: Yun LI, Beijing (CN); Xiaolei WANG, Beijing (CN); Lei ZHANG, Beijing (CN)

(73) Assignees: BEIJING FOUNDER APABI TECHNOLOGY LTD., Beijing (CN); PEKING UNIVERSITY FOUNDER GROUP CO., LTD., Beijing (CN)

(21) Appl. No.: 13/782,848

(22) Filed: Mar. 1, 2013

(30) Foreign Application Priority Data
Mar. 2, 2012 (CN) 201210054272.0

(51) Int. Cl. G06F 17/30

(52) U.S. Cl. CPC G06F 17/30011
USPC 707/624

(57) ABSTRACT

A method and an apparatus for saving a document are disclosed. The method comprises combining data which have been modified but not saved and incremental saving data to be combined. The method further comprises replacing the incremental saving data with the combined data.

### CROSS REFERENCE OF RELATED APPLICATIONS

This application claims the benefit of Chinese patent application No. 201210054272.0, filed on Mar. 2, 2012, which is incorporated by reference in its entirety as part of this application.

### TECHNICAL FIELD

The present application relates to electronic document data processing technologies, in particular, to a method and an apparatus for saving electronic documents.

### BACKGROUND

An electronic document may be edited and saved multiple times. During an editing process, existing data in the document may be modified or deleted. If these modifying and deleting operations are performed directly on the document data source, when an unexpected interruption occurs during a process of writing new data or deleting old data, the document data source may be lost or damaged.

In order to edit and save the document securely, most of the existing document processing software utilizes the following two methods.

In a first method, a temporary file is used to backup an original document and modifying records. In this method, the data of the temporary file may be available to repair the original document if the original document is damaged due to an unexpected interruption during a saving process. However, with this method, a user or program often cannot be aware that the original document has been damaged and thus actively repair the damage.

In a second method, a temporary copy is created for the original document and modified data is written into the temporary copy. After finishing editing, the original document is replaced by the temporary copy by renaming the temporary copy. This method is safer, but the cost in time and storage space for creating and storing a temporary copy of the original document are relatively large. In addition, in some situations, the original document is not allowed to be replaced. In this case, the method may not be useful.

Some electronic document formats, such as PDF, DOC, CEBX, support incremental savings, and allow to append a separate data block at the end of the original document to save modified results. The appended data block contains information on differences between a newly modified document and the last saved results. However, the incremental savings may accumulate and become larger and larger in size, and will take a significant amount of storage space.

### SUMMARY

One aspect of the present invention provides a method for saving a document. According to some embodiments, the method may comprise a step of combining a first set of data for the document and a second set of data for the document, wherein the first set of data have been modified but not saved in the document, and the second set of data comprise incremental saving data. The method may further comprise a step of covering the second set of data with the combined data.

Another aspect provides an apparatus for saving a document. The apparatus may comprise a processor configured to combine a first set of data for the document and a second set of data for the document, and to cover the second data with the combined data. The first set of data have been modified but not saved in the document, and the second set of data may comprise incremental saving data. In some embodiments, the apparatus may further comprise a storage device configured to save the combined data in the end of the document.

### BRIEF DESCRIPTION OF THE DRAWINGS

Exemplary non-limiting embodiments of the present invention are described below with reference to the attached drawings. The drawings are illustrative and generally not to an exact scale. The same or similar elements on different figures are referenced with the same reference numbers.

FIG. 1 is a schematic diagram illustrating an apparatus for saving electronic documents, consistent with some disclosed embodiments.

FIG. 2 is a schematic diagram illustrating an apparatus for saving a document, consistent with some disclosed embodiments.

FIG. 3 is a flowchart illustrating a method for saving a document, consistent with some disclosed embodiments.

FIG. 4 is a schematic diagram of a saving format of an incremental saving in prior art.

FIG. 5 is a flowchart illustrating a further method for saving a document, consistent with some disclosed embodiments.

FIG. 6 is a schematic diagram of a saving format of an incremental saving for generating a set of incremental data in prior art.

FIG. 7 is a flowchart illustrating a first method for saving a document, consistent with some disclosed embodiments.

FIG. 8 is a schematic diagram of a saving format, consistent with some disclosed embodiments.

FIG. 9 is a schematic diagram of an XDA document packing format, consistent with some disclosed embodiments.

FIG. 10 is a schematic diagram of a process for an XDA document incremental saving, consistent with some disclosed embodiments.

FIG. 11 is a schematic diagram of a process for combining incremental data savings of an XDA document, consistent with some disclosed embodiments.

FIG. 12 is a schematic diagram of a process for combining incremental data savings of an XDA document, consistent with some disclosed embodiments.

FIG. 13 is a schematic diagram of a process for combining incremental data savings of an XDA document, consistent with some disclosed embodiments.

### DETAILED DESCRIPTION

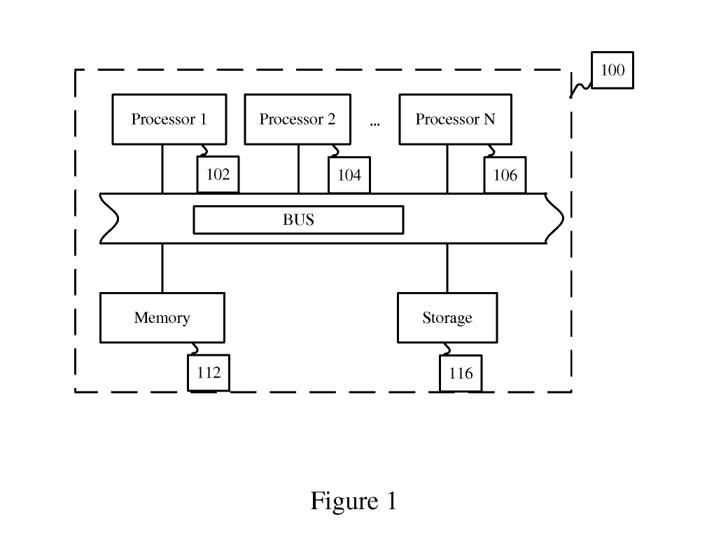

Reference will now be made in detail to exemplary embodiments, examples of which are illustrated in the accompanying drawings. When appropriate, the same reference numbers are used throughout the drawings to refer to the same or like parts. FIG. 1 is a schematic diagram illustrating an exemplary apparatus 100 for saving electronic documents, consistent with some disclosed embodiments.

Apparatus 100 may include a general purpose computer, a computer cluster, a mainstream computer, a computing device dedicated for providing online contents, or a computer network comprising a group of computers operating in a centralized or distributed fashion. As shown in FIG. 1, apparatus 100 may include one or more processors (processors 102, 104, 106 etc.), a memory 112, a storage device 116, a communication interface 114, and a bus to facilitate information exchange among various components of apparatus 100. Processors 102-106 may include a central processing unit (“CPU”), a graphic processing unit (“GPU”), or other suitable information processing devices. Depending on the type of hardware being used, processors 102-106 can include one or more printed circuit boards, and/or one or more microprocessor chips. Processors 102-106 can execute sequences of computer program instructions to perform various methods that will be explained in greater detail below.

Memory 112 can include, among other things, a random access memory (“RAM”) and a read-only memory (“ROM”). Computer program instructions can be stored, accessed, and read from memory 112 for execution by one or more of processors 102-106. For example, memory 112 may store one or more software applications. Further, memory 112 may store an entire software application or only a part of a software application that is executable by one or more of processors 102-106. It is noted that although only one block is shown in FIG. 1, memory 112 may include multiple physical devices installed on a central computing device or on different computing devices.

In some embodiments, storage device 116 may be provided to store a large amount of data, such as databases containing data of a scanned book, image information of the scanned book, layout information of the scanned book, etc. Storage device 116 may also store software applications that are executable by one or more processors 102-106. Storage device 116 may include one or more magnetic storage media such as hard drive disks; one or more optical storage media such as computer disks (CDs), CD-Rs, CD±RWs, DVDs, DVD±Rs, DVD±RWs, HD-DVDs, Blu-ray DVDs; one or more semiconductor storage media such as flash drives, SD cards, memory sticks; or any other suitable computer readable media.

Embodiments consistent with the present disclosure provide methods, systems, apparatuses, and computer readable media for saving electronic documents. During a writing or editing process of an electronic document, the electronic document typically has original data (e.g., when editing an old document), data that has been modified but not been saved, and incremental saving data. The incremental saving data is a data block that saves modified results, which are differences between a newly modified document and the last saved results.

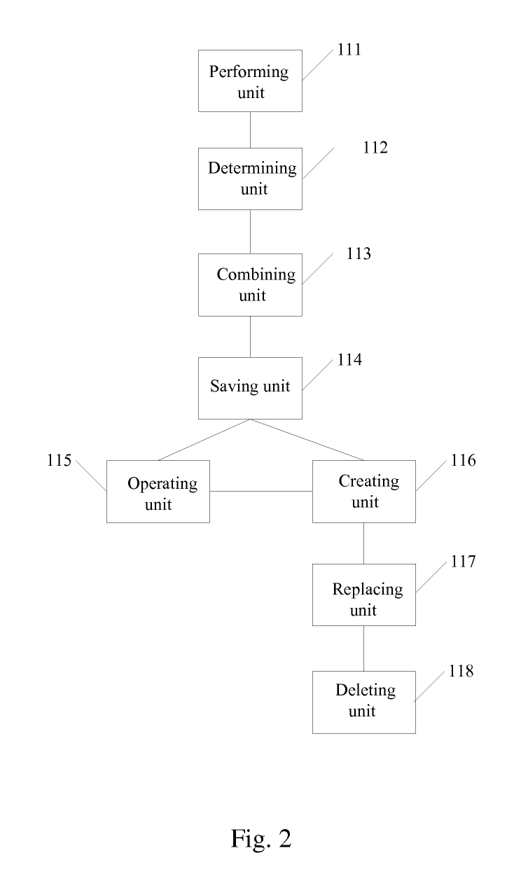

FIG. 2 is a block diagram showing various modules of apparatus 100, consistent with some disclosed embodiments. In some embodiments, as shown in FIG. 2, apparatus 100 may include a performing unit 111, a determining unit 112, a combining unit 113, and a saving unit 114. The performing unit 111 may be configured to determine which data that have been modified but not saved as incremental saving data. The combining unit 113 may be configured to combine: 1) data which has been modified but not been saved, and 2) incremental saving data to be combined. The saving unit 114 may be configured to save the combined data. In some embodiments, the saving unit 114 is configured to determine if a size of the combined data is larger than a size of the incremental saving data to be combined. If yes, the saving unit 114 generates a blank data block appended to the incremental saving data to be combined and saves the combined data. The size of the blank data block is the difference between the size of the combined data and the size the incremental saving data to be combined. Otherwise, if the size of the combined data is smaller than the size of the incremental saving data to be combined, the saving unit 114 saves the combined data without generating the blank data block. In one embodiment, the saving unit 114 may be configured to save the incremental saving data in the end of the document.

Referring to FIG. 2 again, in some embodiments, the apparatus 100 may further include an operating unit 115 configured to activate the combined data while deactivate the incremental saving data to be combined. “Activate” or “deactivate” means to use or not to use, allow access to or not allow access to. The operating unit 115 may be further configured to activate the incremental saving data. The apparatus 100 may further include a replacing unit 117 configured to replace the incremental saving data to be combined with the combined data. In particular, the replacing unit 117 is configured to create a copy of the combined data and replace the deactivated incremental saving data with the copy, and then to activate the copy while deactivate the combined data.

In some embodiments, if there are a plurality of the incremental saving data sets to be combined, the determining unit 112 may be configured to determine whether the plurality of the incremental saving data sets are continuous data stored in the end of the document. If yes, the combining unit 113 combines the data which have been modified but not been saved and incremental saving data sets to be combined. The apparatus 100 may further include a deleting unit 118 configured to delete certain content.

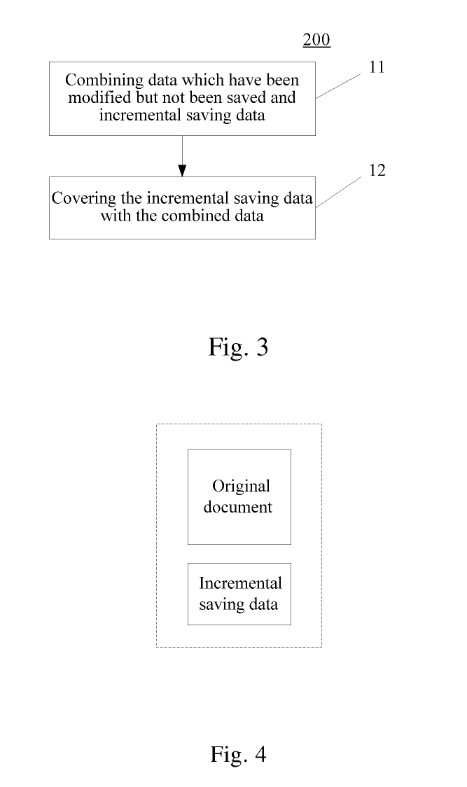

FIG. 3 shows a flowchart illustrating a method for saving a document consistent with some disclosed embodiments. In FIG. 3, process 200 comprises a series of steps that may be performed by one or more of processors 102-106 of apparatus 100 to implement a data processing operation.

In Step 11, the apparatus 100 may combine data which have been modified but not been saved and incremental saving data to be combined. The apparatus 100 may save the combined data in the end of the document. In some embodiments, the apparatus 100 may determine if a size of the combined data is larger than a size of the incremental saving data to be combined. If yes, the apparatus 100 generates a blank data block appended to the incremental saving data to be combined and save the combined data after the generated blank data block. The size of the blank data block is the difference of occupied space between the combined data and the incremental saving data to be combined. Otherwise, if the size of the combined data is smaller than the size of the incremental saving data to be combined, the apparatus 100 saves the combined data after the incremental saving data to be combined. In one embodiment, the apparatus 100 may be configured to save the incremental saving data in the end of the document. And then, the apparatus 100 activates the combined data while deactivates the incremental saving data to be combined.

A person having ordinary skill in the art should appreciate that, in this disclosure, the phrase such as “in the end of the document,” “after,” etc. are used to describe a logical relationship, but not necessary a physical relationship in the storage.

In some embodiments, if the document has been revised many times, each time the system may generate an incremental saving data. If there are a plurality of incremental saving data sets to be combined, the apparatus 100 may determine whether the plurality of the incremental saving data sets to be combined are continuous data stored in the end of the document. If yes, the apparatus 100 combines data which have been modified but not saved and incremental saving data sets to be combined.

In Step 12, the apparatus 100 may replace the incremental saving data to be combined with the combined data. In particular, the apparatus 100 creates a copy of the combined data, and replaces the deactivated incremental saving data with the copy, and then activates the copy while deactivate the combined data. In some embodiments, after the combined data is deactivated, the apparatus 100 may delete the deactivated combined data after the copy of the combined data. In other words, the original version of the combined data may be deleted.

A document format supporting the incremental saving can ensure that a program can find and use each incremental saving data in a certain order. In particular, the document format can allow discontinuous storage for the incremental saving data, or allow some incremental saving data to be treated as empty data blocks in the document or be skipped (i.e. the incremental saving data will not be used) in further proceeding. In the following two conditions, but not limited to the following two conditions, the data cannot be used by the document:

Condition 1: The document usually uses index table to record offset address of all the incremental saving data or the like, or to record an offset address of next incremental saving data in each incremental saving data. Non-indexed data will not be used by the document;

Condition 2: the data are provided with deactivating identifications, and the document treats the data with the deactivating identifications as useless data.

Therefore, in a process of adding or editing the incremental saving data, it can be ensured that the data will not be used by the document (i.e. deactivated) by not adding an index to the data or by providing a deactivating identification to the data. After finishing the operation of adding or editing the incremental saving data, the combined data may be activated in the document by modifying the index or providing an activating identification or the like. That is, it is allowed to use the combined data in the document.

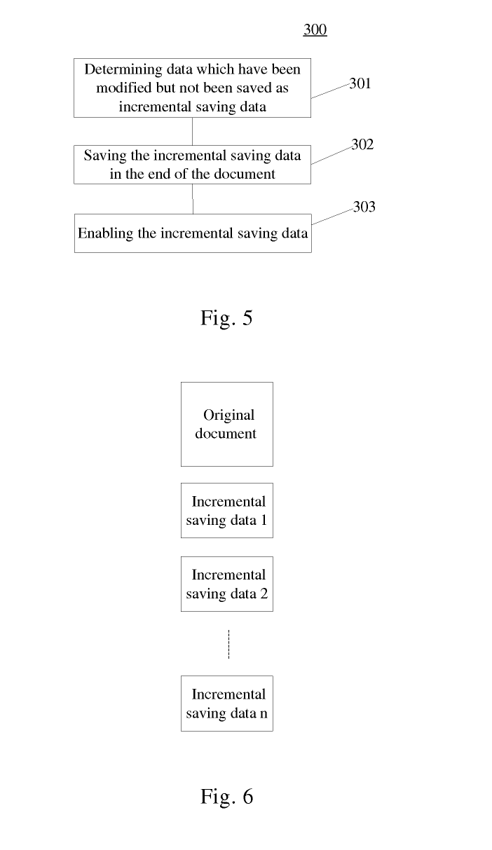

The present application further provides a method for saving a document, in which, after a user modifies a part of the data in the document, the modified data can be saved as incremental saving data in the end of the document in a default incremental saving manner. As shown in FIG. 4, an incremental saving operation uses a pure appending operation, and thus the original data of the document will not be lost. In order to ensure that the document format is always correct, a new incremental saving data cannot be activated in the process of appending the new incremental saving data to the original data. The unwritten data appended in the end of the document cannot be used even when the saving process is unexpectedly interrupted. That is, the document can still be resolved correctly. The incremental saving data are activated and the document saving is completed only when the incremental saving data are completely written. The specific process is described as follows with reference to FIG. 5.

FIG. 5 shows a flowchart of a method for saving a document consistent with another disclosed example. In FIG. 5, process 300 comprises a series of steps that may be performed by one or more of processors 102-106 of apparatus 100 to implement a data processing operation initiated by a user. In particular, in Step 301, the apparatus 100 determines which data have been modified but not been saved as incremental saving data. In Step 302, the apparatus 100 may save the incremental saving data in the end of the document, and then in Step 303 the apparatus 100 may activate the incremental saving data.

As shown in FIG. 6, a plurality of incremental saving data sets will be saved in the end of the document after modifying for many times. When the number of times of the incremental saving operations or the amount of the incremental saving data exceeds a certain threshold or according to a request made by a user, a non-incremental saving can be performed to combine and replace the incremental saving data generated by the incremental saving operations for one time or more times as well as the incremental saving data which have been modified but not saved by the user.

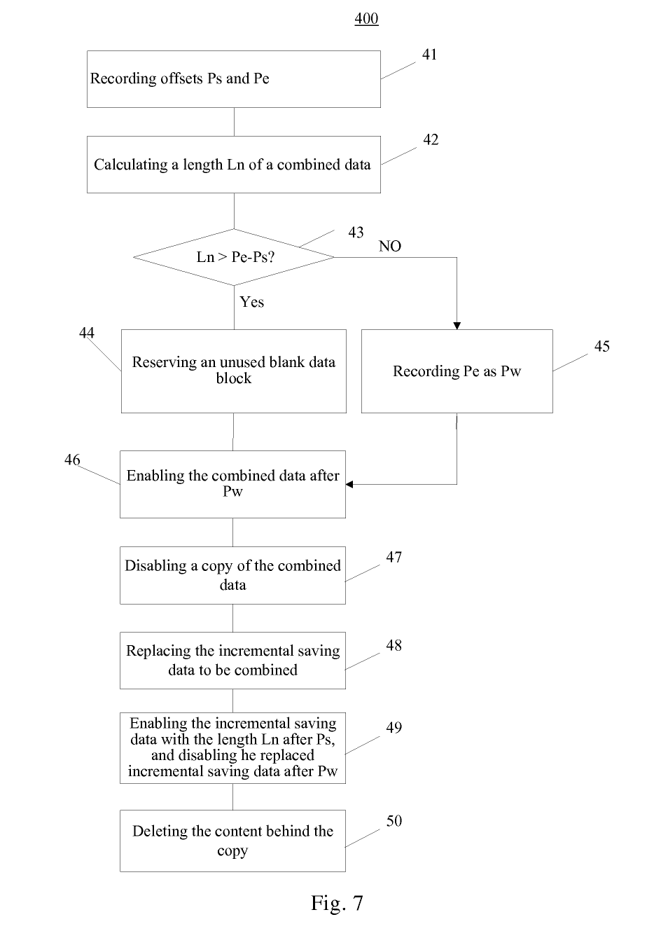

As shown in FIG. 7, the present application provides a second process 400 for saving a document. According to some embodiments, the process 400 comprises a series of steps that may be performed by one or more of processors 102-106 of apparatus 100 to implement a data processing operation initiated by a user.

At step 41, the apparatus 100 records an offset address Ps of an initial position of incremental saving data 1 and an offset address Pe of a current end position of the document. Each offset address is determined with respect to the initial position of the document.

At step 42, the apparatus 100 calculates a length Ln (or size) of combined data that is obtained by combining all the incremental saving data to be combined and the data which have been modified but not saved. As an example, the incremental saving data to be combined can be incremental saving data 1 and incremental saving data 2.

At step 43, the apparatus 100 compares Ln with Pe-Ps. If Ln is smaller than or equal to Pe-Ps, then the method goes to step 45, otherwise goes to step 44.

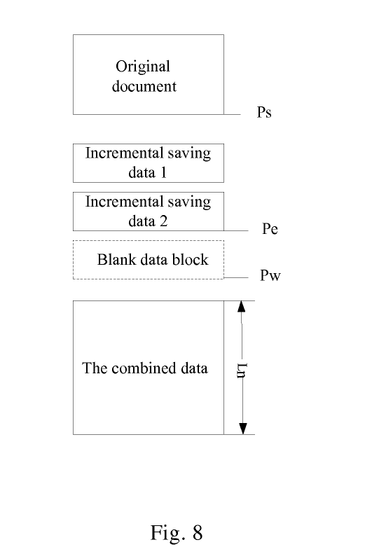

At step 44, the apparatus 100 reserves an unused blank data block in the end of the document, records an offset address Pw of the end position of the document after the reserved blank data block, and then saves the combined data in the end of the document, i.e. after the Pw, as shown in FIG. 8; wherein the size of the blank data block is calculated by Ln-(Pe-Ps).

At step 45, the apparatus 100 records Pe as Pw, and saves the combined data in the end of the document, i.e. after Pw; wherein in the process of saving the combined data, the combined data are not used by the document. For example, the combined data can be deactivated during this time.

At step 46, the apparatus 100 activates the combined data after Pw while all replaced incremental saving data between Ps and Pw are deactivated. The combined data are going to be used to replace all the incremental saving data between Ps and Pw.

At step 47, the apparatus 100 creates a copy of the combined data, and then deactivates the created copy. At step 48, the apparatus 100 uses the created copy to replace the incremental saving data to be combined. In particular, the apparatus 100 writes the copy back into the position between Ps and Pw, forms a new unused data with a length Ln, and replaces all the deactivated incremental saving data. Since the length Ln of the combined data is not larger than Pw-Ps, the writing of the combined data between Ps and Pw will not cover the activated incremental saving data after Pw. In addition, during the process of writing the data back, the data can be deactivated, so that it cannot be used by the document.

At step 49, the apparatus 100 activates the incremental saving data with the length Ln after Ps while the replaced incremental saving data after Pw is deactivated. In particular, if there is a blank data block between Ps+Ln and Pw, then the blank data block shall be adjusted as an unused blank data.

At step 50, the apparatus 100 deletes the content after the copy of the combined data. In particular, the apparatus 100 adjusts the size of the document as Ps+Ln, and thus the data after Ps+Ln is automatically deleted.

In some embodiments, if there are a plurality of the incremental saving data sets to be combined, the system can check, before step 41, whether the plurality of the incremental saving data sets to be combined are continuous data stored in the end of the document. If the data are continuous data, then the apparatus 100 proceeds with the step 41; otherwise, the process 400 can end or proceed according to an existing method in the prior art.

In some embodiments, for the non-incremental saving operation which combines the incremental saving data, the method according to the present application makes a full use of the character of the document which supports the incremental saving. In particular, the combined new data will be saved first and then the old data will be deleted or replaced. If the document is accidentally closed during the saving process, it is ensured as much as possible that the document format is correct and the data are not lost or damaged.

In some embodiments, during the process of saving the document, the operations of writing the data and adjusting the size of the document in steps 44, 45, 48 and 50 take up the majority of the time for the saving process. The method according to the present application can ensure that if there is an unexpected interruption in the steps, the data blocks which are being modified will not be activated by the document, and the document always uses the complete incremental data blocks which have been combined or have not been combined. That is, the document data will not be lost or damaged even the process of saving is interrupted, but can still be used correctly. The interruptions occurred in steps 44, 45 and 50 might leave useless data in the end of the document, and the interruption in step 48 might leave useless data in the middle of the document, but such useless data will not affect the correctness of the document.

In some embodiments, the operations of enabling and replacing the incremental saving data in steps 46 and 49 make the error probability relatively low due to their relatively short time operations. The data of the document are not damaged and can be repaired automatically by a document processing device or guided by a user even when the saving process is unexpected interrupted.

Additionally, the operations of the method according to the present application can be performed on the original document such that the amount of the copied or moved data is small, and the time and space consumptions are reduced. The method is independent from the file system and is appropriate for a variety of storage devices and networking equipments.

At present, many of the electronic document formats use a framework of “physical container+document model” to describe and store data. The physical container is mainly used to store data and is similar to a virtual storage system to organize various types of data description files involved in the document model. Many existing document formats use Zip package as a physical container, such as Microsoft's OOXML, XPS and the like.

According to some embodiments, an electronic document packaging format called XML-based Document Archive (XDA) may be adopted. XDA supports saving a modified data description file in a document model in an incremental saving manner and also supports combining multiple incremental saving results. Any electronic document format which uses the XDA as a physical container can save a modification of the document based on related properties of the XDA and can use all or part of the incremental modification history as a revision history version of the document.

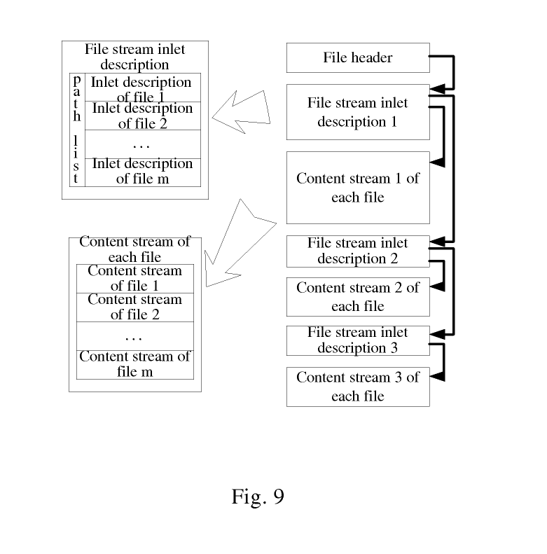

FIG. 9 shows a structure of an XDA document packaging format. The XDA may include a file header, a file stream inlet description and content stream of each file. The file header describes basic information of the XDA's copyright information, the XDA's version number, the number of the file stream inlet description and the like. The file stream inlet description contains the location of each file stream in the file and file information. The content stream of each file is combined in sequence from a plurality of the file streams recorded in the file stream inlet description.

In the XDA document, the file stream inlet description and the content stream of each file appear in pairs to form a set of history of the incremental modification. A pointer of an initial position of the content stream of the respective file, i.e. an effective address of a relative file header, is recorded in a corresponding file stream inlet description. The file stream inlet description further comprises the pointer of an initial position of a next file stream inlet description (it is set to be 0 if there is no next file stream inlet description). The pointer of an initial position of the first file stream inlet description and the total number of the file stream inlet description in the files (that is, the number of the history versions) are recorded in the file header.

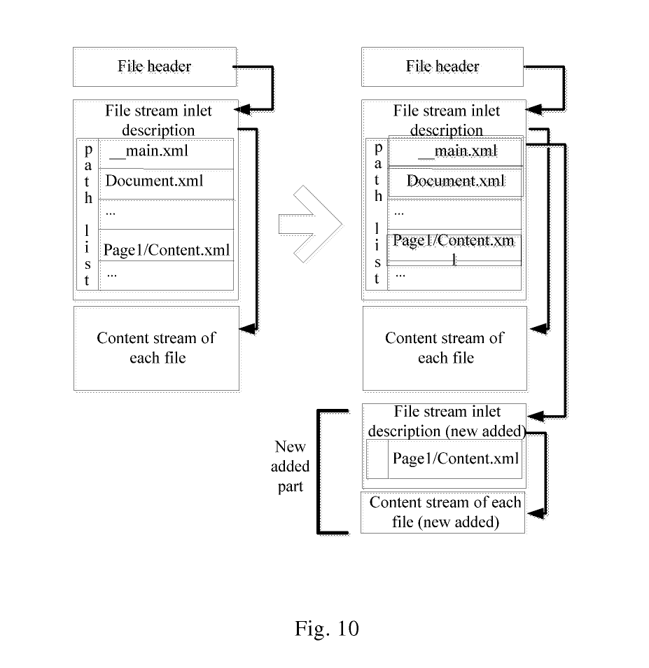

FIG. 10 shows a schematic diagram for incrementally saving an XDA document, which may be performed by one or more of processors 102-106 of apparatus 100. First, the apparatus 100 adds a new file stream inlet description and the content stream of each file in the end of the XDA document, directs the pointer of the original last file stream inlet description to the initial position of the newly added file stream inlet description. In this regard, the history version of the XDA can be determined according to the number of the file stream inlet description and a traversal access can be realized through the link relationship between the file stream inlet descriptions. A file stream inlet description and a corresponding file content stream block can be added when an incremental saving is performed, and it can be considered as that the XDA increases a historical version, that is, a new version of the XDA is generated.

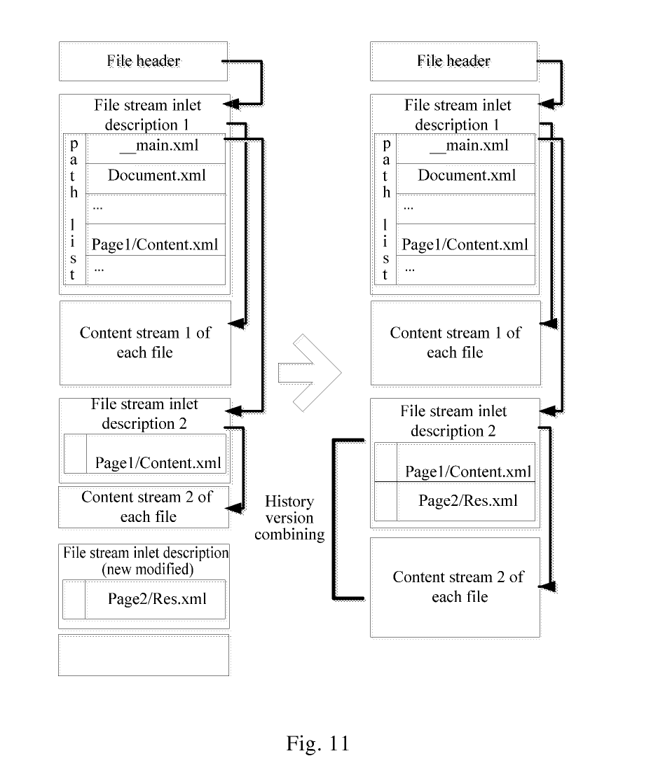

FIG. 11 shows a schematic diagram for combining and saving the incremental data in the XDA document, which may be performed by one or more of processors 102-106 of apparatus 100. In particular, the apparatus 100 combines a new modification and the last modification, rather than saves the new modification as a new history version. The file stream inlet descriptions and the file streams of these two modifications can be combined when the combining and saving operations are performed. If the same file has been modified for more than once, then the most recent result of the modification is saved. The file stream inlet description 2 of the original file and the file data after the combined data can be replaced. If the operations of deleting old data and writing new data are directly performed on the original file, then the data of the original file may be lost such that the irreparable damage may occur if the saving process is accidentally interrupted.

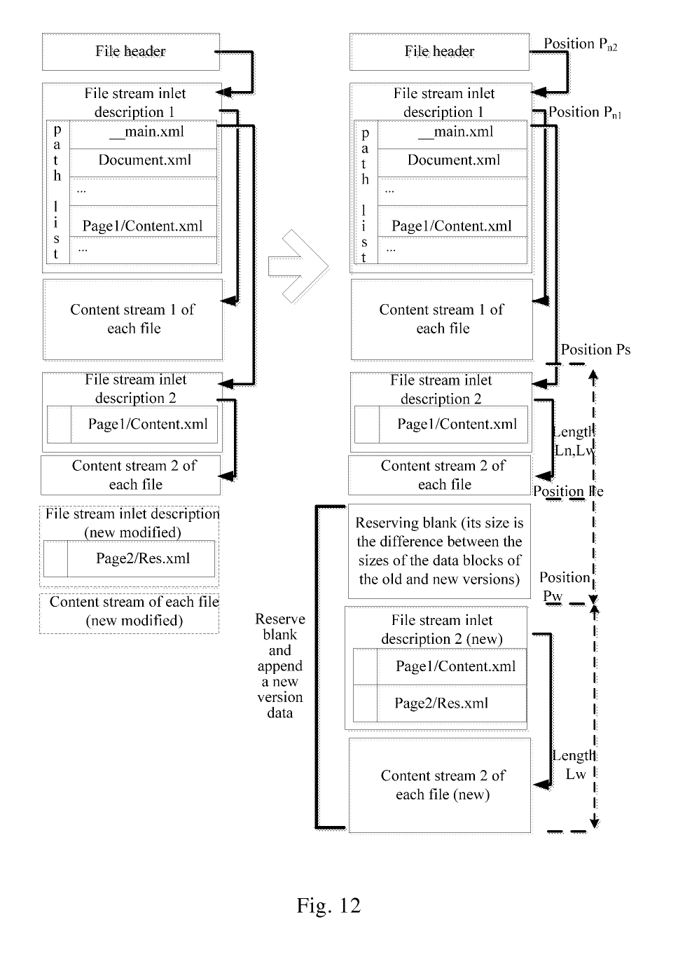

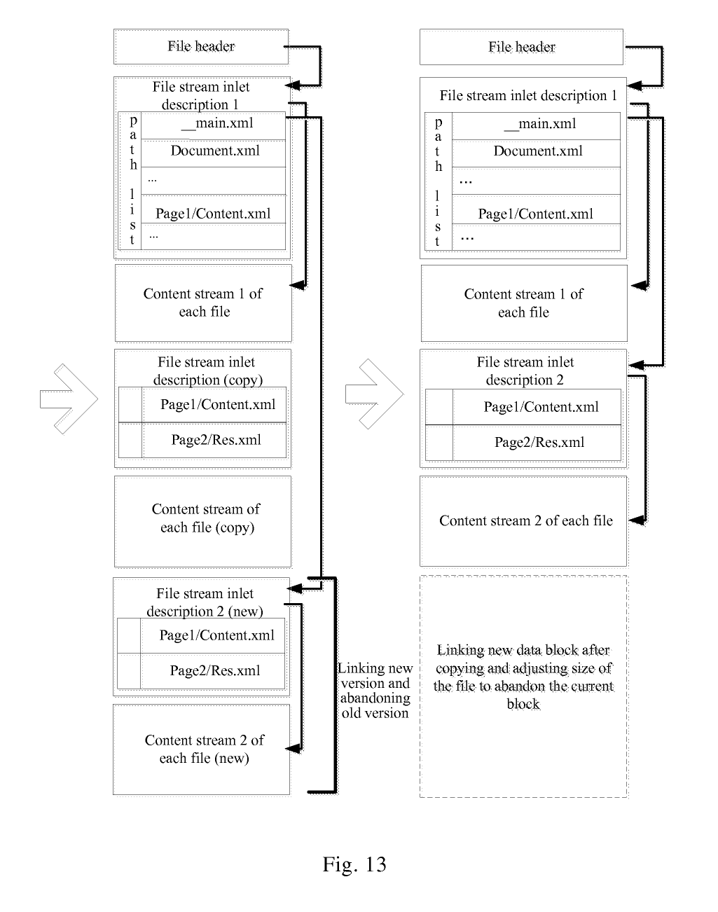

Specifically, as shown in FIGS. 11 to 13, the apparatus 100 records a file stream inlet description of a second history version (i.e. a first plurality of data sets to be combined), an offset address Ps of the initial position and an offset address Pe of the end position of the document, and then calculates a total length Ln of the newly generated file stream inlet description and the data stream of each file. The apparatus 100 takes the largest value Lw (equals to Ln) between Ln and Pe-Ps when Ln is larger than Pe-Ps and writes a blank data block with a length of Pw-Pe in the end of the file.

And then, the apparatus 100 generates a new file stream inlet description and data stream of each file and writes the generated file stream inlet description and data stream of each file from the Pw position, and refreshes the file and clears the temporary cache data. In particular, the XDA records the offset address of the file stream inlet description of the second history version (here is Ps) in a position Pₙ₁ of the first history version, and records the total number of the history versions in a position Pₙ₂ in the file header, the total number here is 2 and it may not be changed.

Further, the apparatus 100 may change the value of the position Pₙ₁ to Pw. Here, the file stream inlet description of the second history version has been switched with Pw as the value of the initial position, while the data between Ps and Pw is abandoned. And then the apparatus 100 copies the data with the length Lw from Pw in the file to replace the original data between Ps and Pw, and modifies the records which point the effective address of each file data stream block in the copied file stream inlet description to the correct effective address. Next, the apparatus 100 changes the previous value of the position Pₙ₁ to Ps and saves the file, that is, replaces the file stream inlet description block of the position Pw by the file stream inlet description block of the effective address Ps, and then the apparatus 100 adjusts the length of the file, abandons the file data after Pw.

Optionally, in the beginning, the apparatus 100 may go through all the file stream inlet descriptions of the XDA document to determine the order of the data and ensure that the history version data to be combined will be stored in sequence in the end position of the file.

With the apparatus and process discussed in the above, the data which have been modified but not saved and the incremental saving data to be combined are combined, and the combined data are saved in the end of the document and the unfinished data cannot be used by the document. In some embodiments, the combined data are activated after the data are completely written while the incremental saving data to be combined are deactivated. A copy of the combined data is created and then the incremental saving data to be combined are replaced by the copy. Here, the document is using the combined data, and thus using the copy to cover the deactivated data to be combined does not damage the document format or lose the document data. In some embodiments, the copy may be activated after the replacing operation is completed while the combined data are prohibited. Here, all data after the copy are no longer used by the document and can be safely deleted. In some embodiments, if there is no need to combine the incremental saving data, the data which have been modified but not saved are directly saved in the end of the document and the data are activated after they are completely written. In this regard, the method can improve the safety for the incremental saving and may ensure that the document format is still correct and no data is lost or damaged even when the unexpected interruption occurs on most of the time points in the saving process.

The embodiments of the present invention may be implemented using certain hardware, software, or a combination thereof. In addition, the embodiments of the present invention may be adapted to a computer program product embodied on one or more computer readable storage media (comprising but not limited to disk storage, CD-ROM, optical memory and the like) containing computer program codes.

In the foregoing descriptions, various aspects, steps, or components are grouped together in a single embodiment for purposes of illustrations. The disclosure is not to be interpreted as requiring all of the disclosed variations for the claimed subject matter. The following claims are incorporated into this Description of the Exemplary Embodiments, with each claim standing on its own as a separate embodiment of the disclosure.

Moreover, it will be apparent to those skilled in the art from consideration of the specification and practice of the present disclosure that various modifications and variations can be made to the disclosed systems and methods without departing from the scope of the disclosure, as claimed. Thus, it is intended that the specification and examples be considered as exemplary only, with a true scope of the present disclosure being indicated by the following claims and their equivalents.

What is claimed is:

1. A method for saving a document in a computer readable storage medium comprising:
combining a first set of data for the document and a second set of data for the document, wherein the first set of data has been modified but not saved in the document, and the second set of data comprises incremental saving data; and
replacing the second set of data with the combined data in the computer readable storage medium.

2. The method according to claim 1, wherein the method further comprises before replacing the second set of data:
saving the combined data in the end of the document.

3. The method according to claim 2, wherein the method further comprises before replacing the second set of data:
activating the combined data; and
deactivating the incremental saving data.

4. The method according to claim 1, wherein the replacing the second set of data comprises:
creating a copy of the combined data;
replacing the incremental saving data with the created copy;
activating the created copy; and
deactivating the combined data.

5. The method according to claim 2, wherein the step of saving further comprises:
determining whether a size of the combined data is larger than a size of the incremental saving data; and
if yes, the saving the combined data in the end of the document comprising:
generating a blank data block;
saving the combined data,
wherein a size of the blank data block is a difference between a size of the combined data and a size of the incremental saving data.

6. The method according to claim 1, wherein, before the combining, the method further comprising:
determining the second set of data are continuous data stored in the end of the document.

7. The method according to claim 4, wherein after the deactivating the combined data, the method further comprises:
deleting the deactivated combined data.

8. A method for editing and saving a document in a computer readable storage medium comprising:
saving a first set of data as a first set of incremental saving data;
generating a second set of data; and
before saving the second set of data, combining the second set of data with the first set of incremental saving data.

9. An apparatus for saving a document in a computer readable storage medium, the apparatus comprising:
a processor configured to:
combine a first set of data for the document and a second set of data for the document, wherein the first set of data has been modified but not saved in the document, and the second set of data comprises incremental saving data; and
replacing the second set of data with the combined data.

10. The apparatus according to claim 9, wherein the processor is further configured to save the combined data in the end of the document.

11. The apparatus according to claim 10, wherein the processor is further configured to activate the combined data and deactivate the incremental saving data.

12. The apparatus according to claim 10, wherein the processor is further configured to replace the second set of data with the combined data by:
creating a copy for the combined data;
replacing the incremental saving data by the created copy;
activating the created copy; and
deactivating the combined data.

13. The apparatus according to claim 10, wherein the processor is further configured to determine whether a size of the combined data is larger than a size of the incremental saving data; and the processor is further configured to save the combined data by:
generating a blank data block; and
saving the combined data,
wherein a size of the blank data block is a difference between a size of the combined data and a size of the incremental saving data.
